(19) United States
(12) Patent Application Publication
(10) Pub. No.: US 2023/0373771 A1
(43) Pub. Date: Nov. 23, 2023

(54) APPARATUS TO PREVENT RING MOVEMENT

(71) Applicant: John DOHERTY, Middle Village, NY (US)

(72) Inventor: John DOHERTY, Middle Village, NY (US)

(21) Appl. No.: 18/197,864

(22) Filed: May 16, 2023

Related U.S. Application Data
(60) Provisional application No. 63/342,875, filed on May 17, 2022.

(30) Foreign Application Priority Data
Jun. 20, 2022 (GB) 2209065.8

(51) Int. Cl. B66F 19/00

(52) U.S. Cl. CPC B66F 19/005

(57) ABSTRACT

A stabilization apparatus for a frame having a cover comprises a lifting head having a horizontal shank with first and second ends, a pair of vertical supports, a vertical support located at each end of the lifting head and a retention leg connected to the shank the retention leg in use configured to exert a downward restraining force on the frame or portion thereof. The apparatus prevents a frame or its edge from being lifted with the cover, and thereby reduce damage to the frame or road and avoiding costly repair. The inventive apparatus is particularly useful to prevent damage to manholes when lifting manhole covers.

### CROSS REFERENCE TO RELATED APPLICATION

This application claims the benefit of priority under 35 U.S.C. § 119(e) to U.S. provisional patent application No. 63/342,875, filed on May 17, 2022, entitled “Apparatus for Protecting Frames”, which is incorporated herein by reference in its entirety. This application also claims the benefit of priority under 35 U.S.C. § 119(a)-(d) to United Kingdom patent application no. GB2209065.8, filed on Jun. 20, 2022, which is incorporated herein by reference in its entirety.

### FIELD OF THE INVENTION

The present invention is directed to improvements in structures for preventing movement of frames having rings and for protecting frames from damage when raising and positioning frame covers such as manhole covers.

### BACKGROUND

There are many tasks that require more strength than a single individual may safely achieve, yet do not warrant the use of heavy machinery. For example, frame covers such as concrete slabs and manhole covers can be very hard to lift and remove from the ground. Although frame covers are usually not very large, they are typically made from materials such as concrete and steel and therefore are extremely heavy and cumbersome to lift and maneuver by a single individual. In practice, frame covers are frequently partially lifted using a single long-handled hook and the covers are then manually moved away from the frame by dragging or using a dolly. Although such methods can be effective, they are inconvenient and cumbrous, and there is a risk that the covers may drop, thereby causing personal injury to a worker or damaging the cover or an adjacent surface, or scratching or gouging the adjacent surface as the cover is dragged.

Frame covers sometimes become unintentionally glued or otherwise stuck to their frames, and it becomes difficult to remove the cover without damaging the frame. For example, manhole covers may become attached to the manhole frame or rim, particularly if road crews are not careful when depositing asphalt or resurfacing a road. When asphalt (or another material) is pressed into a frame or on hot days, the manhole cover can become stuck to the manhole ring, frame, or rim. In such circumstances, lifting the manhole cover can inadvertently lift, crack, or break the rim or ring, thereby requiring costly and inconvenient repair of the manhole frame.

Consequently, it is highly desirable to have an apparatus which addresses the above issues by preventing a ring of a frame (or its edge or other component thereof) from being moved or otherwise lifted with the cover, and thereby reduce damage to the frame or road and avoiding costly repair.

### SUMMARY OF THE INVENTION

The present invention addresses the problems discussed above and provides a stabilization device for stabilizing a frame and preventing movement of a frame ring or edge when lifting adjacent objects such as (but not limited to) frame covers like manhole covers.

One aspect of the present invention is directed to a stabilization apparatus for a frame having a cover. The apparatus comprises a lifting head comprising a horizontal shank with first and second ends; a pair of vertical supports, each vertical support located at a respective end of the lifting head; and a retention leg connected to the shank. The retention leg is structurally configured to exert a downward restraining force on the frame during use of the apparatus, and thereby preventing the frame from being lifted and damaged.

In an embodiment of the invention, the lifting head may be telescoping. In alternative embodiments, the lifting head is non-telescoping and has a fixed length.

In an embodiment, the horizontal shank comprises a rail having a longitudinal slot along part or all of its length for receiving an end of the retention leg, and the retention leg slides along the rail for facile adjustment of position of the retention leg.

In another embodiment, the horizontal shank comprises a rail at each of its first and second ends, and each rail has a longitudinal slot for receiving an end of a retention leg. In this embodiment, there may be a retention leg placed at either end of the horizontal shank. In an alternative embodiment, a retention leg may be placed at each end of the horizontal shank, in which case the apparatus comprises two retention legs. In certain embodiments, there may be more than two retention legs, and they may be distributed at any suitable position along the horizontal shank. In an embodiment of the invention, the retention leg is a turnbuckle, optionally having opposed flat end surfaces.

In an embodiment of the invention, one or more vertical supports may have a stationary base so that the apparatus is stable when placed in position. In other embodiments, one or more vertical supports may have a moveable base such as a wheel so that the apparatus may be moved or rolled to another location. In particular embodiments, the apparatus may have one stationary base and one moveable base. In certain embodiments, a moveable base may be fitted with a lock which can be activated so that the vertical support is in a temporarily stationary position and does not move.

It is understood that the term “base” refers to the bottom end of a vertical support which rests upon the ground. In particular embodiments, the retention leg, the vertical support, or both, may be telescoping so as to have an adjustable length to accommodate the frame or frame cover.

In an embodiment of the invention, the frame may be a manhole, and the frame cover is a manhole cover which is placed on the manhole frame or its rim or edge. Depending on the geometric configuration of the frame and frame cover, it may be preferred to place the retention leg on the periphery of the frame so as to prevent the frame from being lifted when the cover is removed.

In particular embodiments of the invention, the apparatus may be structurally configured such that the lifting head exerts a downward force on the retention leg when lifting a frame cover to thereby urge the frame from lifting. in this manner, the frame is maintained in its original position and does not get lifted or otherwise become detached from the surrounding soil or environment in a manner which would necessitate repair of the frame which would be costly, inconvenient, or otherwise undesirable.

In an embodiment of the invention, the apparatus may comprises a pair of retention legs, and each retention leg is configured for placement on the frame or a part of the frame, such as an edge or rim. The pair of stabilizers may be placed at opposite locations on the frame to provide symmetric forces on the frame, or on the same side of the frame, as may be desirable and thereby prevent its movement. In other embodiments, there may be a plurality of retention legs, such as three, four, or more retention legs. The retention legs may be linear or may be bent, curved, or have another structure which will prevent the frame from moving or lifting when the frame cover is raised or otherwise moved.

In an embodiment of the invention, the apparatus may comprise one or more locks to lock the apparatus in position during use. For example, the locks may be wheel locks to lock a wheel or may be a hasp, pin, lock screws, locking pin, padlock, or other structure suitable to maintain the moveable or telescoping element in a desired configuration, and then the lock may be released after the job is completed or for storage.

In an embodiment of the invention, the horizontal shank of the lifting head may comprise a pair of rails on its bottom surface, on a side surface, or another surface, and the retention leg slides into and along the rails for adjustment of position of the retention leg.

In an embodiment of the invention, the lifting head may have a connector such as a lifting point to which a frame cover lifter may be attached. In one embodiment, the lifting point is an eye loop which is formed as an integral part of the arm. The lifting point may be located at any position on or along the device (for example, at the midpoint; at opposite ends; or at the midpoint and opposite ends), and there may be any number of lifting points, such as one, two, three, four, five, or more. In one embodiment, the lifting point is configured as an integral part of the lifting head. In alternative embodiments, lifting points may be separate structures such as loops having eyes or apertures and are moveable and/or fixable along the lifting head. In other embodiments, the lifting point is a platform on the lifting head to which the frame cover lifter is attached. In an exemplary embodiment, the stabilization apparatus has one lifting point along the midpoint of the lifting head. In an alternative embodiment, there may be two or more lifting points on the lifting head. In general, it is desirable for the lifting point(s) to be positioned such that the apparatus is balanced when used to stabilize a frame, for example, at complementary locations, thereby minimizing uneven weight stresses on the inventive stabilization apparatus or the frame.

The stabilization apparatus may be used with frames having covers such as manhole covers or other covering structures or other heavy objects as may be found useful. The frame can have any shape, such as round, square, or rectangular. The stabilization apparatus may be manufactured from any particular material or combination of materials such as (but not limited to) structural steel, high tensile steel, alloys such as aluminum alloys, and composites and synthetics such as fiber-reinforced plastic. It may be desirable in particular instances to apply a coating (for example, paint, electroplate, or powder coating) to the components of the stabilization apparatus to prevent oxidation or deterioration, or to label particular sizes with the same color to facilitate identification. In one embodiment, the device may have indicia such as a manufacturer's logo or device.

Another aspect of the invention is directed to a lifting system for lifting or otherwise removing a frame cover from a frame. An embodiment of this aspect of the invention comprises the inventive stabilization apparatus according to any embodiment or combination of embodiments discussed herein and a frame cover lifting device connected thereto. Exemplary lifting devices for covers are described in PCT/US2022/029143 to Doherty, filed on May 13, 2022 and entitled “Lifting Device for Covers”, which is incorporated herein by reference in its entirety. The lifting system is structurally configured for lifting the frame cover from the frame without lifting or shifting the frame or frame rim. The lifting device may be any structure such as a pull hook bar, crowbar, hook-and-eye, pull hook, which can be used to connect the frame cover to the stabilization apparatus and to lift or otherwise remove the frame cover from the frame.

The frame cover lifting device may comprise a lifting mechanism. The lifting mechanism raises or lowers the lifting device and thereby the frame cover, and may be manually-operated or electrically-operated. Examples of lifting mechanisms include a winch, pulley, jack, or other mechanism that can raise the lifting device and frame cover. Certain embodiments of lifting systems may include a support structure such as a frame or scaffold. The lifting mechanism is attached to the device at the lifting point using a chain, rope, irons, hoop, coil, shackle, clamp, screw, rivet, or other suitable connector. In an embodiment of this aspect, the frame cover is a manhole.

### BRIEF DESCRIPTION OF THE DRAWINGS

The foregoing and other objects and advantages will be apparent upon consideration of the following detailed description, taken in conjunction with the accompanying drawings, in which:

FIG. 1 is a front view of an exemplary embodiment of a stabilization apparatus according to an aspect of the invention.

FIG. 2 is a front view of an embodiment of a retention leg in the form of a turnbuckle.

FIG. 3 is a front view of an embodiment of the inventive in use to lift a manhole from a manhole ring.

FIG. 4 is a side view of the stationary support of the embodiment of the invention shown in FIG. 3.

FIG. 5 is a perspective view of underside of the embodiment shown in FIG. 3.

FIG. 6 is a side view of a stationary support of the embodiment shown in FIG. 3.

FIG. 6A is a cross-sectional view of the horizontal shank of the embodiment shown in FIG. 3.

FIG. 7 is a cross sectional perspective view of the horizontal shank of the embodiment shown in FIG. 3.

FIG. 7A is a view of the jack plate of the embodiment shown in FIG. 3.

FIG. 8 is a plan of the underside of the horizontal shank of the embodiment shown in FIG. 3.

### DETAILED DESCRIPTION

The invention will now be described with reference to the Figures, wherein like reference numerals refer to like elements.

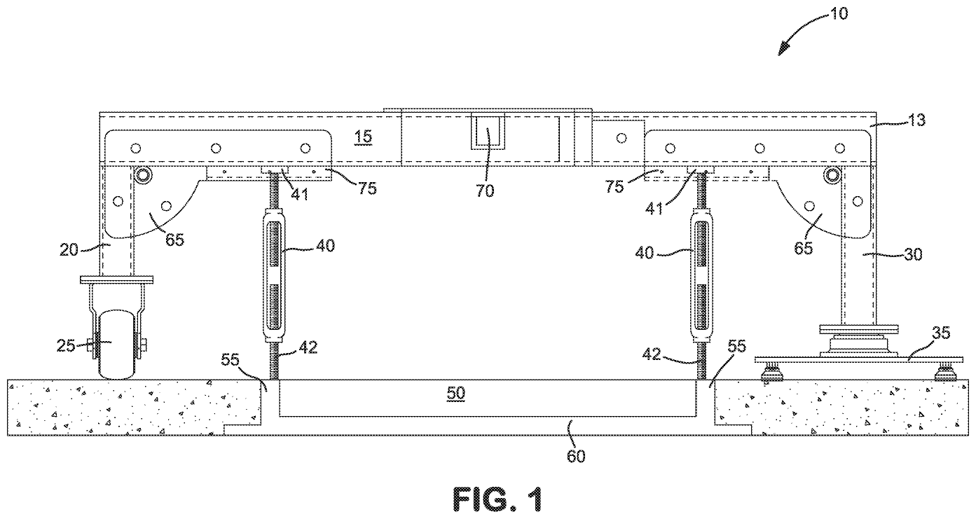

FIG. 1 is a front view of an exemplary embodiment of a stabilization apparatus for a frame having a cover, in accordance with one aspect of the present invention. The apparatus prevents movement of a ring (or other portion such as an edge or side) of a frame so that the frame cover can be lifted without damaging the frame. The term “ring” is to be understood as an edge or side of a frame, and the frame does not necessarily need to be circular but may be square, rectangular, or have another shape.

The stabilization apparatus 10 comprises a lifting head 13 or gantry encompassing a horizontal shank 15 and has opposite first and second ends. At each end of the lifting head 13 is a vertical support 20, 30. The pair of vertical supports 20, 30 in FIG. 1 are non-identical. In alternative embodiments, the vertical supports 20, 30 can be identical, depending upon the particular implementation of the invention. A pair of retention legs 40 in the form of turnbuckles are affixed to the lifting head 13 and provide a downward force on the edge 55 of the frame 60 during use of the apparatus 10. The lifting head 13 has a pair of rails 75 at each end for receiving a retention leg 40.

Each vertical support 20, 30 may comprise a strengthening gusset 65 in an interior or elbow region between the vertical support 20, 30 and the horizontal shank 15 for reinforcement and improved resistance to bending or other deformation. In one embodiment, the strengthening gusset 65 may be molded as an integral component of the vertical support 20, 30 (or the horizontal shank 15) to provide increased strength to the inventive apparatus and thereby help prevent it from collapsing or bending from the weight of a load. In alternative embodiments, the strengthening gusset 65 may be a separate component which is affixed to the horizontal shank 15 and each vertical support 20, 30.

The vertical supports 20, 30 may have any convenient configuration. In the embodiment illustrated in FIG. 1, the first vertical support 20 has a swiveling wheel 25 at its base, and the second vertical support 30 has a flat and wide base 35. The wheel 25 of the vertical support 20 allows the position of the inventive stabilization apparatus 10 to be adjusted as necessary, while the flat stationary base 35 of the second vertical support 30 provides stability to the apparatus. The wheel 25 may be fitted with a lock (not illustrated) to prevent the wheel from unintended shifting of the vertical support 20 during use of the apparatus. The flat stationary base 35 may have feet, rubber pads, or other structures to enhance grip or reduce slippage.

In the embodiment illustrated in FIG. 1, the lifting head 13 of the stabilization apparatus 10 has a length of about 44 inches (about 112 cm) and an overall height of about 15 inches (about 38 cm). The turnbuckles 40 are zinc-coated steel and have a thread diameter of ⅝″. The upper end of the turnbuckles 40 has a 1¾″×⅜″ metal flange 41 which is inserted into the rail 75 at the underside of the lifting head 13. The lower end 42 of the turnbuckle is illustrated with a flat cylindrical configuration. The wheel 25 has a diameter of 3 inches (75 mm), and a width of 0.9 inches (23 mm). The wheel 25 is attached to a swiveling wheel plate which is 2.6 inches×3.2 inches (66 mm×82 mm). The wheel is able to swivel and thereby permits facile movement of the apparatus, for example, when the stationary leg is lifted and apparatus is pushed to roll it along a road or other surface via the swiveling wheel.

The stabilization apparatus 10 may be longer than the frame 60 so that the vertical supports 20, 30 of the apparatus 10 can be positioned on the ground adjacent to the frame 60 during use of the device. The lifting head 13 in FIG. 1 may be telescoping so that the apparatus has a reduced configuration for storage, and an expanded configuration which is customizable to correspond to a desired length for use. The lifting head 13 may also be fitted with a lock (not illustrated) so that the lifting head 13 remains in a desired expanded configuration during use or in a collapsed configuration for storage.

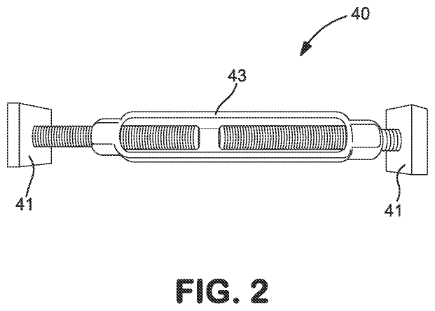

FIG. 2 provides a front view of a turnbuckle 40 suitable for use as a retention leg. The turnbuckle 40 comprises an open body 43 and first and second flat-bottomed flange fittings 41 that turn in opposite directions via screw threads to adjust the length of the turnbuckle. Although each of the end fittings 41 are shown with a flat bottom, either or both fittings may have different configurations (for example, as shown in FIG. 1) which are suitable for urging a frame from lifting, or for connection to the lifting head 13. In alternative embodiments, elements such as (but not limited to) an adjustable rod can be used in place of a turnbuckle 40.

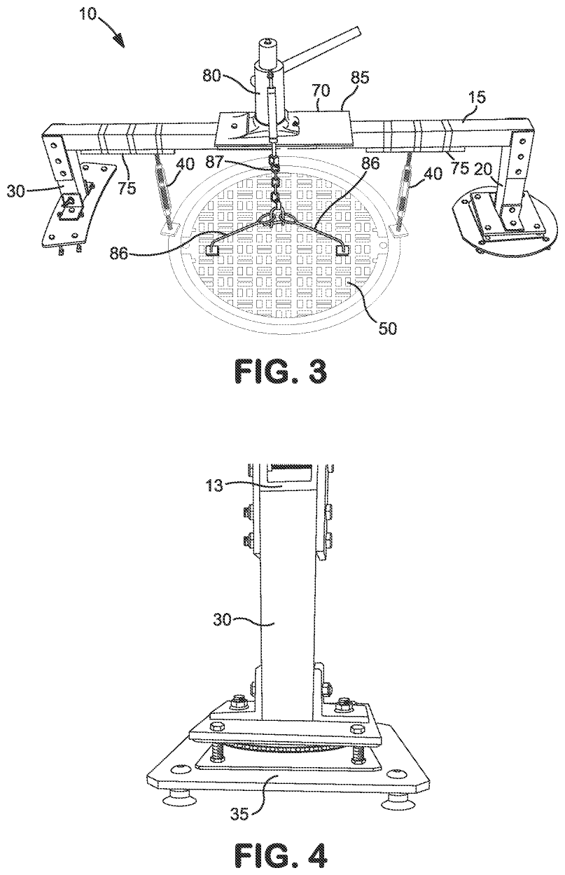

FIG. 3 is a front perspective view of an embodiment of the inventive stabilization apparatus 10 in use to lift a manhole cover 50 from a manhole frame 60. In FIG. 3, the inventive apparatus 10 is placed over a manhole frame 60 and the two vertical supports 20, 30 straddle the manhole frame 60. One end of each of the two retention legs 40 is fitted into the retention leg rail 75 and the other end placed on the rim 55 of the manhole 60 and outside the cover 50. A lifting device 86 (in this embodiment, a pair of puller hooks) is inserted into holes of the manhole cover 50 for gripping the manhole cover 50 and the hooks 86 are affixed to a shackle 88 which is chained 87 to a to a hand-operated winch 80 affixed to the middle of the lifting head 13 at a lifting point 70. To remove the manhole cover 50, the winch is activated and the force of the stabilization apparatus 10 on the retention legs 40 prevents the manhole rim 55 from lifting and becoming damaged as the manhole cover 50 is lifted. In certain embodiments, the lifting head 13 may be in the form of a gantry.

FIG. 4 is a side view of the stationary support 30 of the embodiment of the invention shown in FIG. 3. The stationary support 30 is affixed at its bottom to a base 35 and at its top to the shank of the lifting head 13. In the illustrated exemplary embodiment, the stationary support 30 can swivel on the base 35 to adjust the position of the stabilization apparatus on the ground.

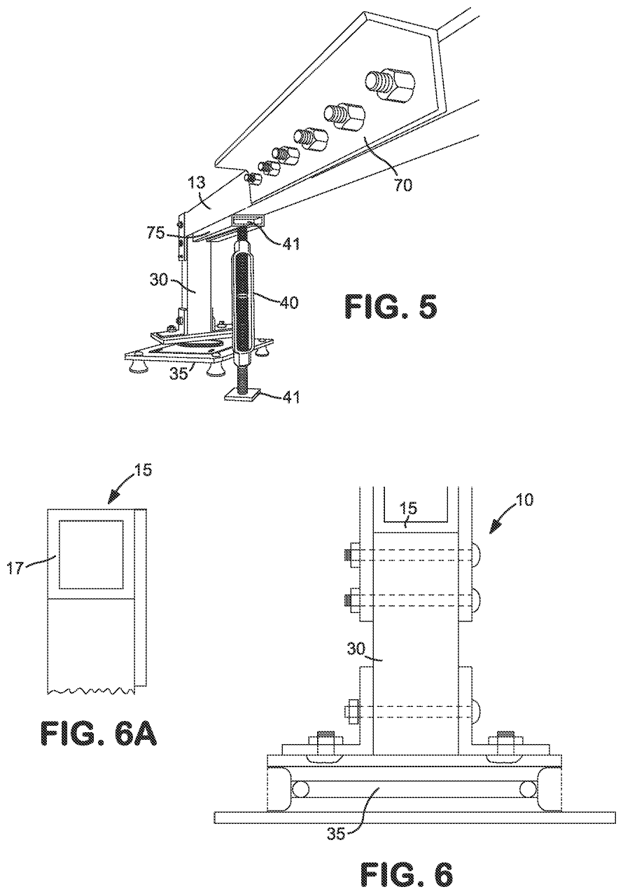

FIG. 5 is a perspective view of underside of the embodiment shown in FIG. 3. In this embodiment, the flange 41 of the turnbuckle 40 is inserted into the slot of horizontal rail 75. The rail 75 is open at its end so that the flange 41 can be inserted therein. A lifting point 70 is located at the midpoint of the lifting head 13 and comprises a jack plate 85 which is bolted or otherwise fastened to the lifting head 13. The jack plate 85 provide a flat surface on which a winch 80 or other device can be installed for lifting up a frame cover.

FIG. 6 is a side view of a stationary support 30 of the embodiment shown in FIG. 3. The stationary support 30 has a base 35 at its bottom and is affixed to the horizontal shank 15 using bolts, screws, or other fasteners. The stationary support may optionally have a swiveling base, as shown in FIG. 4, to adjust the position of the inventive stabilization apparatus on the ground. In such an embodiment, the swiveling base may have a locking mechanism such as a lock, pin, screw, or other structure, which fixes the position of the stationary support 30 on the ground.

FIG. 6A is a cross-sectional view of the horizontal shank 15 of the embodiment shown in FIG. 3. The horizontal shank 15 of the lifting head is has a rectangular or square interior. In one embodiment, the horizontal shank is a 2 inch×2 inch×¼ inch (5 cm×5 cm×0.6 cm) aluminum or steel tube 17 which is 48 inches (122 cm) long.

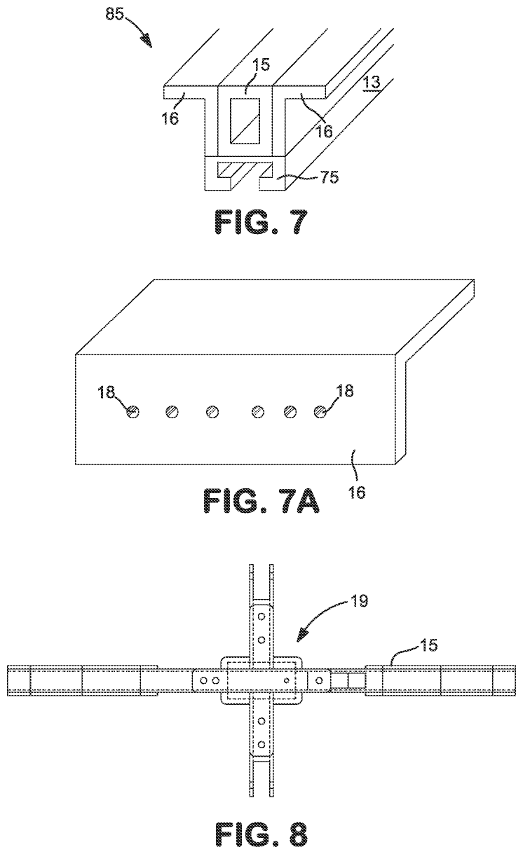

FIG. 7 is a cross sectional perspective view of the horizontal shank 15 of the lifting head 13 of the embodiment shown in FIG. 3. The shank 13 comprises a square tube 17 which is 2 in ×2 in ×¼ in, and two L-shaped brackets 16 (also seen in FIG. 7A) form a jack plate platform. The jack plate 85 is clamped or otherwise fastened to the shank 15 to thereby advantageously provide additional strength and structural stability to the lifting head 13. A horizontal rail 75 is affixed to the bottom of the horizontal shank 15 via screws or other fasteners for receiving the flange of a retention leg (e.g. 40). In other embodiments, it is understood that the horizontal rail 75 may be substituted with another structure which can receive a retention leg 40. The retention leg 40 may advantageously be able to slide in the horizontal rail 75 to a desired position, but the retention leg 40 may equally be permanently fixed in a particular position, for example, using fasteners such as bolts or screws. FIG. 7A is a perspective view of the jack plate 16 of the embodiment previously discussed having holes 18 for receiving a bolt or screw for fastening to the lifting head 13.

FIG. 8 is a plan view of the underside of the horizontal shank 15 of the embodiment shown in FIG. 3. The shank 15 may be telescoping or have a fixed length which will depend on the particular implementation of the invention. In FIG. 8, a cross-strut 19 is shown as being affixed at a 90 degree angle to the shank 15 to provide an additional surface for mounting a lifting device.

Another aspect of the invention is directed to a lifting system for lifting a frame cover such as a manhole cover. The system comprises the stabilization apparatus as discussed herein in any of its embodiments and a lifting device which clamps or otherwise grips the frame cover. In further embodiments, the system may comprise a lifting mechanism which can raise or lower the lifting device to facilitate removal of the cover from the frame. The lifting mechanism may be motorized and powered by electricity, hydraulics, or other principles, or it may be manually-operated. The system allows for lifting of the frame cover while preventing the frame from lifting and being damaged.

The use of the inventive apparatus will now be described with reference to FIG. 1. The stabilization apparatus 10 is positioned over or alongside the frame 60. The flat bottomed flanges 41 of the retention legs 40 are inserted into the rails 45 and their position in the rails is adjusted so that the bottoms 42 of the retention legs 40 are resting upon the edge or rim 55 of the frame 60. The length of the turnbuckle 40 is adjusted so that its length is suitable for the particular frame.

A lifting device (not illustrated) is attached to both the lifting head 13 at the lifting point 75 and also to the frame cover 50 to be lifted, for example, into holes or interstices in the frame cover which are configured for receiving the lifting device. The sequence of these particular steps is not critical and they can be performed in any suitable order. The lifting device is then activated, and the upwards force on the lifting head 13 is transferred to the retention legs 40 which press downward upon the rim 55 of the frame 60 as the cover 50 is removed. This downward force prevents, or at least significantly reduces the likelihood of, the rim 55 of the frame 60 from being lifted or otherwise detached or damaged when the frame.

In accordance with an embodiment of the invention, the inventive stabilization apparatus may be used in conjunction with a standalone multipurpose lifting device such as that described in US 2016/0368748 to Doherty, which is incorporated herein by reference in its entirety. The present invention may also be used in conjunction with lifting devices for covers such as those described in PCT/US2022/029143 to Doherty, filed on May 13, 2022 and entitled “Lifting Device for Covers”, which is incorporated herein by reference in its entirety.

Examples of changes, substitutions, and alterations are ascertainable by one skilled in the art and could be made without departing from the scope of the invention disclosed herein. All references cited herein are incorporated by reference in their entirety and made part of this application.

The various embodiments described above can be combined to provide further embodiments. Aspects of the embodiments can be modified to provide yet further embodiments. The disclosed features may be implemented, in any combination and sub-combination (including multiple dependent combinations and sub-combinations), with one or more other features described herein, even if not expressly recited or described. The various features described or illustrated above, including any components thereof, may be combined or integrated in other systems. In addition, the embodiments described in the dependent claims can be combined with other independent claims to provide still further embodiments, even if not expressly recited or described. Moreover, certain features may be omitted or not implemented. Any individual features of the invention discussed herein may also be combined with other features, without limitation, even if not expressly described.

Other objects, advantages and embodiments of the various aspects of the present invention will be apparent to those who are skilled in the field of the invention and are within the scope of the description and the accompanying figures. For example, but without limitation, structural or functional elements might be rearranged, or method steps reordered, consistent with the present invention. Similarly, an element may comprise a single instance of an element or comprise a plurality of elements, such plurality functioning as a single unitary component. The structure of the invention described in various embodiments is not meant to limit the invention to those embodiments or aspects of the present invention, and other components that may accomplish similar tasks may be implemented as well. Similarly, principles according to the present invention, and methods and systems that embody them, could be applied to other examples, which, even if not specifically described here in detail, would nevertheless be within the scope of the present invention.

What is claimed is:

1. A stabilization apparatus for a frame having a cover, the apparatus comprising:
a lifting head comprising a horizontal shank with first and second ends;
a pair of vertical supports, a vertical support located at each end of the lifting head; and
a retention leg connected to the shank, wherein the retention leg in use is configured to exert a downward restraining force on the frame or a portion thereof.

2. The apparatus according to claim 1, wherein the lifting head is telescoping.

3. The apparatus according to claim 1, wherein the horizontal shank comprises a rail having a longitudinal slot along its length for receiving an end of the retention leg, and the retention leg slides along the rail for adjustment of position of the retention leg.

4. The apparatus according to claim 1, wherein the horizontal shank comprises a rail at each of the first and second ends, and each rail has a longitudinal slot for receiving an end of a retention leg.

5. The apparatus according to claim 1, wherein at least one vertical support has a stationary base.

6. The apparatus according to claim 1, wherein at least one vertical support has a moveable base.

7. The apparatus according to claim 6, wherein the moveable base is a wheel.

8. The apparatus according to claim 1, wherein the frame is a manhole and the cover is a manhole cover.

9. The apparatus according to claim 1, wherein the retention leg is telescoping.

10. The apparatus according to claim 1, wherein the lifting head has a connector for connection to a frame cover lifter.

11. The apparatus according to claim 1, wherein the apparatus is structurally configured such that the lifting head exerts a downward force on the retention leg when lifting a frame cover to thereby urge the edge of the frame from lifting.

12. The apparatus according to claim 1, wherein the apparatus comprises a pair of retention legs, and each retention leg is configured for placement on the edge of the frame.

13. The apparatus according to claim 1, wherein the retention leg is a turnbuckle.

14. The apparatus according to claim 1, further comprising one or more locks to lock the apparatus in position during use.

15. A lifting apparatus for lifting a frame cover from a frame, the lifting apparatus comprising the stabilization apparatus of claim 1 and a lifting device connected thereto, the lifting device structurally configured for lifting the frame cover from the frame.
